(19) United States
(12) Patent Application Publication
(10) Pub. No.: US 2018/0254457 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventor: Takahiro MATSUO, Niihama-shi (JP)

(21) Appl. No.: 15/910,450

(22) Filed: Mar. 2, 2018

(30) Foreign Application Priority Data
Mar. 3, 2017 (JP) 2017-041093

(51) Int. Cl. H01M 2/16; H01M 2/14

(52) U.S. Cl. CPC H01M 2/1653; H01M 2/1686; H01M 2/145

(57) ABSTRACT

Provided is a nonaqueous electrolyte secondary battery separator that is excellent in rate characteristic maintenance ratio of a nonaqueous electrolyte secondary battery after a cycle of charge and discharge of the nonaqueous electrolyte secondary battery. A nonaqueous electrolyte secondary battery separator including: a polyolefin porous film, the nonaqueous electrolyte secondary battery separator having a photoelastic coefficient of not less than 3.0×10⁻¹¹ m²/N and not more than 20×10⁻¹¹ m²/N with respect to light having a wavelength of 590 nm.

This Nonprovisional application claims priority under U.S.C. § 119 on Patent Application No. 2017-041093 filed in Japan on Mar. 3, 2017, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”).

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

As a separator for use in such a nonaqueous electrolyte secondary battery, a porous film containing polyolefin as a main component is mainly used.

For example, Patent Literature 1 discloses that a polyolefin microporous film whose birefringence falls within a specific range is excellent in withstanding voltage and electric resistance, and can be used as a nonaqueous electrolyte secondary battery separator.

### CITATION LIST

### Patent Literature

### [Patent Literature 1]

Specification of International Publication No. 2012/090632 (Publication Date: Jul. 5, 2012)

### SUMMARY OF INVENTION

### Technical Problem

Note, however, that Patent Literature 1 fails to disclose a photoelastic coefficient that is equivalent to a change in birefringence of a polyolefin porous film of Patent Literature 1 to which polyolefin porous film a stress is applied.

Further, a nonaqueous electrolyte secondary battery separator including such a conventional polyolefin porous film as disclosed in Patent Literature 1 causes a nonaqueous electrolyte secondary battery to have an insufficient rate characteristic maintenance ratio after a cycle of a charge and discharge of the nonaqueous electrolyte secondary battery.

### Solution to Problem

An aspect of the present invention includes the following [1] through [4]:

[1] A nonaqueous electrolyte secondary battery separator including: a polyolefin porous film,

the nonaqueous electrolyte secondary battery separator having a photoelastic coefficient of not less than 3.0×10⁻¹¹ m²/N and not more than 20×10⁻¹¹ m²/N with respect to light having a wavelength of 590 nm.

[2] A nonaqueous electrolyte secondary battery laminated separator including: a nonaqueous electrolyte secondary battery separator mentioned in [1]; and an insulating porous layer.
[3] A nonaqueous electrolyte secondary battery member including: a positive electrode; a nonaqueous electrolyte secondary battery separator mentioned in [1] or a nonaqueous electrolyte secondary battery laminated separator mentioned in [2]; and a negative electrode, the positive electrode, the nonaqueous electrolyte secondary battery separator or the nonaqueous electrolyte secondary battery laminated separator, and the negative electrode being provided in this order.
[4] A nonaqueous electrolyte secondary battery including: a nonaqueous electrolyte secondary battery separator mentioned in [1] or a nonaqueous electrolyte secondary battery laminated separator mentioned in [2].

### Advantageous Effects of Invention

A nonaqueous electrolyte secondary battery separator in accordance with an embodiment of the present invention yields an effect such that a nonaqueous electrolyte secondary battery including the nonaqueous electrolyte secondary battery separator has a high rate characteristic maintenance ratio after a cycle of charge and discharge of the nonaqueous electrolyte secondary battery.

### BRIEF DESCRIPTION OF DRAWINGS

FIG. 1 schematically illustrates a structure of a polyolefin porous film whose birefringence is low.

FIG. 2 schematically illustrates a structure of a polyolefin porous film whose birefringence is high.

### DESCRIPTION OF EMBODIMENTS

The following description will discuss an embodiment of the present invention. The present invention is, however, not limited to the embodiment below. The present invention is not limited to the arrangements described below, but may be altered in various ways by a skilled person within the scope of the claims. Any embodiment based on a proper combination of technical means disclosed in different embodiments is also encompassed in the technical scope of the present invention. Note that numerical expressions such as “A to B” herein mean “not less than A and not more than B” unless otherwise stated.

### Embodiment 1: Nonaqueous Electrolyte Secondary Battery Separator

A nonaqueous electrolyte secondary battery separator in accordance with Embodiment 1 of the present invention is a nonaqueous electrolyte secondary battery separator including: a polyolefin porous film, the nonaqueous electrolyte secondary battery separator having a photoelastic coefficient of not less than 3.0×10−11 m²/N and not more than 20×10⁻¹¹ m²/N with respect to light having a wavelength of 590 nm.

The “photoelastic coefficient” refers to an amount of displacement of a birefringence of a nonaqueous electrolyte secondary battery separator in accordance with an embodiment of the present invention to which nonaqueous electrolyte secondary battery separator a given stress is applied. The “photoelastic coefficient” which is higher causes a greater change in birefringence of the nonaqueous electrolyte secondary battery separator to which a stress is applied.

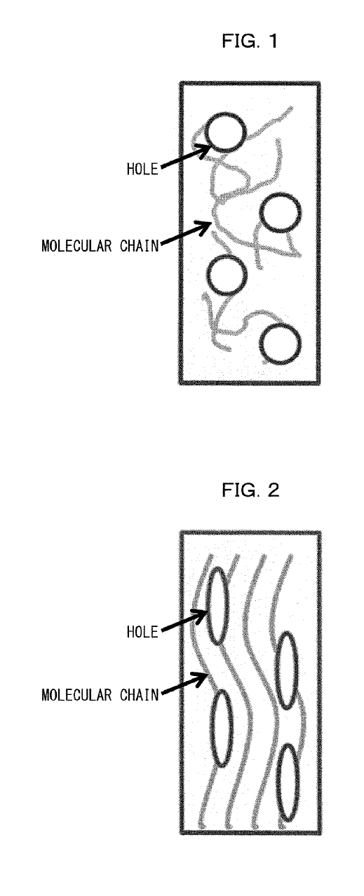

A polyolefin porous film which is included in a nonaqueous electrolyte secondary battery separator in accordance with an embodiment of the present invention and has a low birefringence has a structure in which holes of the polyolefin porous film and molecular chains of polyolefin (“MOLECULAR CHAIN” in FIG. 1) are less oriented (see FIG. 1). Meanwhile, the polyolefin porous film which has a high birefringence has a structure in which holes of the polyolefin porous film and molecular chains of polyolefin (“MOLECULAR CHAIN” in FIG. 2) are greatly oriented (see FIG. 2).

Thus, the “photoelastic coefficient” which is low means that holes of the polyolefin porous film of the nonaqueous electrolyte secondary battery separator and molecular chains of polyolefin less change in orientation, i.e., the orientation is less likely to change, in a case where a stress is applied to the nonaqueous electrolyte secondary battery separator.

According to a nonaqueous electrolyte secondary battery, expansion and shrinkage of electrodes are repeated in a cycle of charge and discharge of the nonaqueous electrolyte secondary battery. Thus, as the cycle of charge and discharge of the nonaqueous electrolyte secondary battery is repeated, a stress (load) caused by the electrodes which expand and shrink is repeatedly applied to a nonaqueous electrolyte secondary battery separator.

In a case where a nonaqueous electrolyte secondary battery separator has a too low photoelastic coefficient and a stress is applied thereto, an internal structure of the nonaqueous electrolyte secondary battery separator can be said to be less likely to change in accordance with the stress, i.e., can be said to be less flexible. Thus, the stress caused by the electrodes which expand and shrink may cause the nonaqueous electrolyte secondary battery separator and the electrodes to be broken. As a result, the nonaqueous electrolyte secondary battery has a lower rate characteristic after the cycle of charge and discharge thereof. From this viewpoint, a nonaqueous electrolyte secondary battery separator in accordance with an embodiment of the present invention has a photoelastic coefficient of preferably not less than 3.0×10⁻¹¹ m²/N, and more preferably not less than 5.0×10⁻¹¹ m²/N.

Meanwhile, in a case where a nonaqueous electrolyte secondary battery separator has a too high photoelastic coefficient, the stress caused by the electrodes which expand and shrink causes a great change in orientation of (i) holes of the polyolefin porous film of the nonaqueous electrolyte secondary battery separator and (ii) molecular chains of polyolefin, i.e., a great change in internal structure of the nonaqueous electrolyte secondary battery separator. As a result, the nonaqueous electrolyte secondary battery is considered to have a lower rate characteristic after the cycle of charge and discharge thereof. Further, the internal structure of the nonaqueous electrolyte secondary battery separator is greatly changed also by a stress that is applied to the nonaqueous electrolyte secondary battery separator during assembly of the nonaqueous electrolyte secondary battery. As a result, the nonaqueous electrolyte secondary battery may have a lower rate characteristic. From this viewpoint, a nonaqueous electrolyte secondary battery separator in accordance with an embodiment of the present invention has a photoelastic coefficient of not more than 20×10⁻¹¹ m²/N, preferably not more than 17×10⁻¹¹ m²/N, and more preferably not more than 15×10⁻¹¹ m²/N.

Note here that the photoelastic coefficient can be measured by, for example, the following method.

From a nonaqueous electrolyte secondary battery separator (polyolefin porous film), a piece measuring 6 cm (MD)×2 cm (TD) is cut out. On the piece of the polyolefin porous film, 0.5 mL of ethanol is dropped. The piece is impregnated with the ethanol, so that a semitransparent film is obtained. In this case, excess ethanol which was not absorbed by the piece is wiped off and removed. Then, a birefringence (phase difference) at 25° C., with respect to light having a wavelength of 590 nm, of the semitransparent film thus obtained is measured by use of a phase difference measuring device. This birefringence is defined as a birefringence to be obtained in a case where a stress of 0 N is applied to the semitransparent film.

Subsequently, a birefringence of the semitransparent film to which a tension (stress) of 3 N is applied is measured by use of the phase difference measuring device. Further, by increasing, in increments of 1 N, the tension (stress), which is applied to the semitransparent film, so that the tension (stress) finally reaches 9 N, birefringences of the semitransparent film to which respective tensions (stresses) are applied are measured by use of the phase difference measuring device. In a graph in which a stress applied is a horizontal axis and a birefringence obtained is a vertical axis, a least squares method is used to (i) draw a straight line based on points indicative of respective measurement results and (ii) calculate a slope of the straight line. The slope of the straight line is regarded as the photoelastic coefficient.

Note that the phase difference measuring device can be a commercially-available phase difference measuring device.

A nonaqueous electrolyte secondary battery separator in accordance with Embodiment 1 of the present invention includes a polyolefin porous film, and is preferably made of a polyolefin porous film. Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the whole of materials of which the porous film is made.

The polyolefin porous film can be a base material of a nonaqueous electrolyte secondary battery separator in accordance with an embodiment of the present invention or a base material of a laminated separator for a nonaqueous electrolyte secondary battery (hereinafter referred to as a “nonaqueous electrolyte secondary battery laminated separator”) in accordance with an embodiment of the present invention, which nonaqueous electrolyte secondary battery laminated separator will be described later. The polyolefin porous film, which has therein many pores connected to one another, allows a gas and a liquid to pass therethrough from one surface to the other surface thereof.

The polyolefin-based resin which the polyolefin porous film contains as a main component is exemplified by but not particularly limited to a homopolymer (e.g., polyethylene, polypropylene, polybutene) and a copolymer (e.g., an ethylene-propylene copolymer) each of which is a thermoplastic resin and is produced by polymerizing monomer(s) such as ethylene, propylene, 1-butene, 4-methyl-1-pentene, and/or 1-hexene.

The polyolefin-based resin more preferably contains a high molecular weight component having a weight-average molecular weight of 3×10⁵ to 15×10⁶. In particular, the polyolefin-based resin which contains a high molecular weight component having a weight-average molecular weight of not less than 1,000,000 is more preferable. This is because such a polyolefin-based resin allows the polyolefin porous film and a nonaqueous electrolyte secondary battery laminated separator including the polyolefin porous film to have a higher strength.

The polyolefin porous film can include a layer containing only one of these polyolefin-based resins or a layer containing two or more of these polyolefin-based resins, and such a layer is made up of a single layer or two or more layers.

Among these polyolefin-based resins, polyethylene is more preferable. This is because polyethylene is capable of preventing (shutting down) a flow of an excessively large electric current at a lower temperature.

Examples of the polyethylene include low-density polyethylene, high-density polyethylene, linear polyethylene (an ethylene-α-olefin copolymer), and ultra-high molecular weight polyethylene having a weight-average molecular weight of not less than 1,000,000.

The polyolefin porous film has a thickness that is not particularly limited but is preferably 4 μm to 40 μm, and more preferably 5 μm to 20 μm.

The polyolefin porous film which has a thickness of not less than 4 μm is preferable. This is because such a polyolefin porous film makes it possible to sufficiently prevent an internal short circuit caused by, for example, breakage of a battery from occurring in a nonaqueous electrolyte secondary battery including a nonaqueous electrolyte secondary battery separator or a nonaqueous electrolyte secondary battery laminated separator in which the polyolefin porous film is used.

Meanwhile, the polyolefin porous film which has a thickness of not more than 40 μm is preferable. This is because such a polyolefin porous film (i) makes it possible to reduce an increase in resistance to permeation of lithium ions all over the nonaqueous electrolyte secondary battery separator or the nonaqueous electrolyte secondary battery laminated separator in which the polyolefin porous film is used, (ii) makes it possible to prevent a deterioration, caused by repeating a cycle of charge and discharge of the nonaqueous electrolyte secondary battery, in positive electrode, rate characteristic, and/or cycle characteristic from occurring in the nonaqueous electrolyte secondary battery including the nonaqueous electrolyte secondary battery separator or the nonaqueous electrolyte secondary battery laminated separator, and (iii) makes it possible to prevent the nonaqueous electrolyte secondary battery per se from being larger in size in accordance with an increase in distance between the positive electrode and a negative electrode.

The polyolefin porous film only needs to have a weight per unit area which weight is appropriately determined in view of a strength, a thickness, a mass, and handleability of each of the nonaqueous electrolyte secondary battery separator including the polyolefin porous film and the nonaqueous electrolyte secondary battery laminated separator including the polyolefin porous film. Specifically, the polyolefin porous film ordinarily has a weight per unit area of preferably 4 g/m² to 20 g/m², and more preferably 5 g/m² to 12 g/m² so that a battery including the nonaqueous electrolyte secondary battery separator or the nonaqueous electrolyte secondary battery laminated separator has a high weight energy density and a high volume energy density.

The polyolefin porous film has a Gurley air permeability of preferably 30 sec/100 mL to 500 sec/100 mL, and more preferably 50 sec/100 mL to 300 sec/100 mL. The polyolefin porous film which has the above Gurley air permeability allows each of a nonaqueous electrolyte secondary battery separator including the polyolefin porous film and a nonaqueous electrolyte secondary battery laminated separator including the polyolefin porous film to achieve sufficient ion permeability.

The polyolefin porous film has a porosity of preferably 20% by volume to 80% by volume, and more preferably 30% by volume to 75% by volume so that (i) a greater amount of an electrolyte can be retained by the polyolefin porous film and (ii) a function of preventing (shutting down) a flow of an excessively large current at a lower temperature without fail can be achieved. The polyolefin porous film which has a porosity of not less than 20% by volume is preferable. This is because such a polyolefin porous film makes it possible to reduce a resistance of the polyolefin porous film. The polyolefin porous film which has a porosity of not more than 80% by volume is preferable in terms of a mechanical strength of the polyolefin porous film.

Pores of the polyolefin porous film have a diameter of preferably not more than 0.3 μm, and more preferably not more than 0.14 μm so that each of a nonaqueous electrolyte secondary battery separator including the polyolefin porous film and a nonaqueous electrolyte secondary battery laminated separator including the polyolefin porous film (i) can achieve sufficient ion permeability and (ii) can prevent particles from entering the positive electrode and/or the negative electrode.

A nonaqueous electrolyte secondary battery separator in accordance with an embodiment of the present invention can include, as necessary, a porous layer in addition to the polyolefin porous film. Examples of such a porous layer include a porous layer of a nonaqueous electrolyte laminated separator (described later) and other publicly known porous layer(s) such as a heat-resistant layer, an adhesive layer, and/or a protective layer.

[Method of Producing Polyolefin Porous Film]

The polyolefin porous film can be produced by a method that is exemplified by but not particularly limited to a method in which a polyolefin-based resin and an additive are melted and kneaded, and then extruded so as to obtain a polyolefin resin composition, and the obtained polyolefin resin composition is stretched, cleaned, dried, and/or heat-fixed.

Specifically, the polyolefin porous film can be produced by a method including the following steps of:

(A) obtaining a polyolefin resin composition by feeding polyolefin-based resin powder and an additive (e.g., a pore forming agent) into a kneader, and melting and kneading a resultant mixture in the kneader;

(B) obtaining a sheet polyolefin resin composition by extruding, through a T-die of an extruder, the polyolefin resin composition which has been obtained in the step (A), and then forming the polyolefin resin composition into a sheet while cooling the polyolefin resin composition;

(C) stretching the sheet polyolefin resin composition which has been obtained in the step (B);

(D) cleaning, by use of a cleaning liquid, the polyolefin resin composition which has been stretched in the step (C); and

(E) obtaining a polyolefin porous film by drying and/or heat-fixing the polyolefin resin composition which has been cleaned in the step (D).

In the step (A), the polyolefin-based resin is used in an amount of preferably 6% by weight to 45% by weight, and more preferably 9% by weight to 36% by weight, with respect to 100% by weight of the polyolefin resin composition to be obtained.

Examples of the additive which is used in the step (A) include phthalate esters such as dioctyl phthalate, unsaturated higher alcohols such as oleyl alcohol, saturated higher alcohols such as stearyl alcohol, a petroleum resin, and liquid paraffin.

Examples of the petroleum resin include (i) aliphatic hydrocarbon resins obtained by polymerizing C5 petroleum fractions, such as isoprene, pentene, and pentadiene, which serve as principal materials of the aliphatic hydrocarbon resins, (ii) aromatic hydrocarbon resins obtained by polymerizing C9 petroleum fractions, such as indene, vinyl toluene, and methyl styrene, which serve as principal materials of the aromatic hydrocarbon resins, (iii) copolymer resins of the resins (i) and (ii), (iv) alicyclic saturated hydrocarbon resins obtained by hydrogenating the resins (i) to (iii), and (v) mixtures of the resins (i) to (iv).

In particular, a pore forming agent such as liquid paraffin is preferably used as the additive.

The above additives can be used alone or can be used in combination. In particular, a combination of liquid paraffin and a petroleum resin is preferable.

In the step (B), the polyolefin resin composition can be cooled by, for example, bringing the polyolefin resin composition into contact with a refrigerant such as cool air or cooling water, or bringing the polyolefin resin composition into contact with a cooling roller. The polyolefin resin composition is preferably cooled by being brought into contact with the cooling roller.

In the step (C), the sheet polyolefin resin composition can be stretched by use of a commercially-available stretching apparatus. More specifically, the sheet polyolefin resin composition can be stretched by causing a chuck to hold both sides of the sheet polyolefin resin composition, or can be stretched by changing a rotation speed of a roller on which the sheet polyolefin resin composition is to be transferred.

The sheet polyolefin resin composition which is being stretched has a temperature of not more than a crystalline melting point of a polyolefin-based resin, preferably not less than 80° C. and not more than 125° C., and more preferably not less than 100° C. and not more than 120° C.

The sheet polyolefin resin composition can be stretched only in an MD direction, only in a TD direction, or both in the MD direction and in the TD direction. Assume that the sheet polyolefin resin composition is stretched both in the MD direction and in the TD direction. In this case, the sheet polyolefin resin composition can be sequentially biaxially stretched, i.e., stretched in the MD direction and subsequently stretched in the TD direction, or can be simultaneously biaxially stretched, i.e., stretched in the MD direction and in the TD direction simultaneously.

Note that a “machine direction (MD) (also referred to as ‘MD direction’) of a polyolefin porous film” herein means a transfer direction in which a polyolefin porous film is transferred while being produced. Note also that a “transverse direction (TD) (also referred to as ‘TD direction’) of a polyolefin porous film” herein means a direction perpendicular to the MD of a polyolefin porous film.

During the stretching of the sheet polyolefin resin composition in at least one of the MD direction and the TD direction, it is preferable to carry out an operation to reduce a stretch ratio after the sheet polyolefin resin composition is temporarily stretched at a high stretch ratio and before the stretch ratio is fixed. The above operation is preferably carried out during the stretching of the sheet polyolefin resin composition in the MD direction. An operation to resiliently reduce the stretch ratio from a high stretch ratio before the sheet polyolefin resin composition has been plastically deformed is preferably continuously carried out, and more preferably continuously carried out in a single stretching apparatus.

The operation can be carried out by, for example, temporarily stretching the sheet polyolefin resin composition at a stretch ratio of 7 times and then continuously gradually reducing the stretch ratio to 6 times. In this case, a maintenance ratio of the stretch ratio is calculated at 86% by dividing 6 times by 7 times.

The maintenance ratio of the stretch ratio is preferably 55% to 95%, and more preferably 60% to 90%. Note that the maintenance ratio of the stretch ratio can be calculated based on the following equation.

Maintenance ratio of stretch ratio=stretch ratio after stretching/stretch ratio during stretching×100

In a case where the above operation to reduce the stretch ratio is carried out, a polyolefin porous film to be obtained tends to be more flexible and have a higher photoelastic coefficient.

The sheet polyolefin resin composition is stretched in the MD direction at a stretch ratio of preferably not less than 1.3 times and less than 7.5 times, and more preferably not less than 1.4 times and not more than 7.0 times. The sheet polyolefin resin composition is stretched in the TD direction at a stretch ratio of preferably not less than 3 times and less than 7 times, and more preferably not less than 4.5 times and not more than 6.5 times. In a case where a stretch ratio is reduced, the reduced stretch ratio means the above stretch ratio. The sheet polyolefin resin composition is stretched at a temperature of preferably not more than 130° C., and more preferably 110° C. to 120° C.

The cleaning liquid which is used in the step (D) can be any solvent provided that the solvent allows an unnecessary additive such as a pore forming agent to be removed. Examples of the cleaning liquid include heptane and dichloromethane.

In the step (E), a polyolefin porous film is obtained by removing the above cleaning solvent from the polyolefin resin composition which has been cleaned in the step (D), and then heat-fixing the polyolefin resin composition by heat-treating the polyolefin resin composition at a specific temperature.

The polyolefin resin composition is heat-fixed at a temperature of preferably not more than 130° C., and more preferably not less than 110° C. and not more than 130° C.

As described earlier, in a case where the maintenance ratio of the stretch ratio is controlled in the step (C) so that the maintenance ratio falls within the above range, flexibility of a polyolefin porous film to be obtained can be suitably controlled. Further, in a case where a petroleum resin is used as an additive to thus control the maintenance ratio of the stretch ratio in the step (C), flexibility of a polyolefin porous film to be obtained tends to be more suitably controllable, and a polyolefin porous film that has a suitable photoelastic coefficient tends to be obtainable.

### Embodiment 2: Nonaqueous Electrolyte Secondary Battery Laminated Separator

A nonaqueous secondary battery laminated separator in accordance with Embodiment 2 of the present invention includes: a nonaqueous electrolyte secondary battery separator in accordance with Embodiment 1 of the present invention; and an insulating porous layer. Thus, the nonaqueous secondary battery laminated separator in accordance with Embodiment 2 of the present invention includes the polyolefin porous film of the above-described nonaqueous electrolyte secondary battery separator in accordance with Embodiment 1 of the present invention.

[Insulating Porous Layer]

An insulating porous layer of a nonaqueous electrolyte secondary battery laminated separator in accordance with an embodiment of the present invention is ordinarily a resin layer containing a resin, and is preferably a heat-resistant layer or an adhesive layer. The resin of which the insulating porous layer (hereinafter also merely referred to as a “porous layer”) is made is preferably a resin that is insoluble in a nonaqueous electrolyte of a battery and that is electrochemically stable when the battery is in normal use.

The porous layer is disposed on one surface or both surfaces of the nonaqueous electrolyte secondary battery separator as necessary. In a case where the porous layer is disposed on one surface of the polyolefin porous film, the porous layer is disposed preferably on that surface of the polyolefin porous film which surface faces a positive electrode of a nonaqueous electrolyte secondary battery to be produced, more preferably on that surface of the polyolefin porous film which surface is in contact with the positive electrode.

Examples of the resin of which the porous layer is made include polyolefins, (meth)acrylate-based resins, fluorine-containing resins, polyamide-based resins, polyimide-based resins, polyester-based resins, rubbers, and resins whose melting point or glass transition temperature is not less than 180° C., and water-soluble polymers.

Among the above resins, polyolefins, polyester-based resins, acrylate-based resins, fluorine-containing resins, polyamide-based resins, and water-soluble polymers are preferable. As the polyamide-based resins, wholly aromatic polyamides (aramid resins) are preferable. As the polyester-based resins, polyarylates and liquid crystal polyesters are preferable.

The porous layer can contain fine particles. The term “fine particles” herein means organic fine particles or inorganic fine particles generally referred to as a filler. Therefore, in a case where the porous layer contains fine particles, the above resin contained in the porous layer has a function as a binder resin of binding (i) fine particles together and (ii) fine particles and the porous film. The fine particles are preferably insulating fine particles.

Examples of the organic fine particles contained in the porous layer include resin fine particles.

Specific examples of the inorganic fine particles contained in the porous layer include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are insulating fine particles. The porous layer can contain (i) only one kind of the fine particles or (ii) a combination of two or more kinds of the fine particles.

Among the above fine particles, fine particles made of an inorganic matter is suitable. Fine particles made of an inorganic oxide such as silica, calcium oxide, magnesium oxide, titanium oxide, alumina, mica, zeolite, aluminum hydroxide, or boehmite are more preferable. Further, fine particles made of at least one kind selected from the group consisting of silica, magnesium oxide, titanium oxide, aluminum hydroxide, boehmite, and alumina are still more preferable. Fine particles made of alumina are particularly preferable.

The porous layer contains the fine particles at a proportion of preferably 1% by volume to 99% by volume, and more preferably 5% by volume to 95% by volume. The porous layer which contains the fine particles at a proportion falling within the above range makes it less likely for a void, which is formed when fine particles come into contact with each other, to be blocked by a resin or the like. This (i) allows the nonaqueous electrolyte secondary battery laminated separator to achieve sufficient ion permeability and (ii) allows the porous layer to have a proper weight per unit area.

The porous layer can contain a combination of two or more kinds of fine particles which two or more kinds differ from each other in particle and/or specific surface area.

The porous layer has a thickness, per surface of the nonaqueous electrolyte secondary battery laminated separator, of preferably 0.5 μm to 15 μm, and more preferably 2 μm to 10 μm.

The porous layer which has a thickness of less than 1 μm may make it impossible to sufficiently prevent an internal short circuit caused by, for example, breakage of a battery. The porous layer which has a thickness of less than 1 μm may also cause the porous layer to retain a smaller amount of an electrolyte. Meanwhile, in a case where the porous layer which is disposed on both surfaces of the nonaqueous electrolyte secondary battery separator has a thickness of more than 30 μm in total, a nonaqueous electrolyte secondary battery may deteriorate in rate characteristic or cycle characteristic.

The porous layer has a weight per unit area, per surface of the nonaqueous electrolyte secondary battery laminated separator, of preferably 1 g/m² to 20 g/m², and more preferably 4 g/m² to 10 g/m².

The porous layer contains component(s) thereof in a volume per square meter, per surface of the nonaqueous electrolyte secondary battery laminated separator, of preferably 0.5 cm³ to 20 cm³, more preferably 1 cm³ to 10 cm³, and still more preferably 2 cm³ to 7 cm³.

In order for the nonaqueous electrolyte secondary battery laminated separator to achieve sufficient ion permeability, the porous layer has a porosity of preferably 20% by volume to 90% by volume, and more preferably 30% by volume to 80% by volume. In order for the nonaqueous electrolyte secondary battery laminated separator to achieve sufficient ion permeability, the porous layer has pores whose diameter is preferably not more than 3 μm, and more preferably not more than 1 μm.

[Laminate]

A laminate, which is a nonaqueous secondary battery laminated separator in accordance with Embodiment 2 of the present invention, includes: a nonaqueous secondary battery separator in accordance with an embodiment of the present invention; and an insulating porous layer, and is preferably arranged to include: a nonaqueous secondary battery separator in accordance with an embodiment of the present invention; and an insulating porous layer (described earlier) disposed on one surface or both surfaces of the nonaqueous secondary battery separator.

A laminate in accordance with an embodiment of the present invention has a thickness of preferably 5.5 μm to 45 μm, and more preferably 6 μm to 25 μm.

A laminate in accordance with an embodiment of the present invention has a Gurley air permeability of preferably 30 sec/100 mL to 1000 sec/100 mL, and more preferably 50 sec/100 mL to 800 sec/100 mL.

Note that a laminate in accordance with an embodiment of the present invention can include, as necessary, publicly known porous film(s) (porous layer(s)) such as a heat-resistant layer, an adhesive layer, and/or a protective layer in addition to the polyolefin porous film and the insulating porous layer, provided that such porous film(s) (porous layer(s)) does/do not impair an object of the present invention.

A laminate in accordance with an embodiment of the present invention includes, as a base material, a nonaqueous electrolyte secondary battery separator that has a photoelastic coefficient falling within a specific range. This allows a nonaqueous electrolyte secondary battery that includes the laminate as a nonaqueous electrolyte secondary battery laminated separator to have a higher rate characteristic maintenance ratio after a cycle of charge and discharge of the nonaqueous electrolyte secondary battery.

[Method of Producing Porous Layer and Method of Producing Laminate]

An insulating porous layer in accordance with an embodiment of the present invention and a laminate in accordance with an embodiment of the present invention each can be produced by, for example, depositing an insulating porous layer by coating a surface of a polyolefin porous film of a nonaqueous electrolyte secondary battery separator in accordance with an embodiment of the present invention with a coating liquid (described later) and drying the polyolefin porous film whose surface has been coated with the coating liquid.

Note that a surface of a polyolefin porous film of a nonaqueous electrolyte secondary battery separator in accordance with an embodiment of the present invention which surface is to be coated with a coating liquid can be subjected to a hydrophilization treatment as necessary before being coated with the coating liquid.

A coating liquid that is used for each of a method of producing a porous layer of an embodiment of the present invention and a method of producing a laminate in accordance with an embodiment of the present invention can be ordinarily prepared by dissolving, in a solvent, a resin that may be contained in the porous layer, and dispersing, in the solvent, fine particles that may be contained in the porous layer. Note here that a solvent in which to dissolve a resin also serves as a dispersion medium for dispersing fine particles therein. Note also that the resin can be contained in the solvent in a form of an emulsion without being dissolved in the solvent.

The solvent (dispersion medium) is not particularly limited provided that the solvent (dispersion medium) (i) does not adversely affect the polyolefin porous film, (ii) allows the resin to be uniformly and stably dissolved therein, and (iii) allows the fine particles to be uniformly and stably dispersed therein. Specific examples of the solvent (dispersion medium) include water and an organic solvent. It is possible to use only one kind of the above solvents, or to use two or more kinds of the above solvents in combination.

The coating liquid can be prepared by any method provided that the coating liquid can satisfy conditions necessary for obtainment of a desired porous layer, such as a resin solid content (resin concentration) and a fine particle content. Specific examples of the method of preparing the coating liquid include a mechanical stirring method, an ultrasonic dispersion method, a high-pressure dispersion method, and a media dispersion method. The coating liquid can contain additive(s) such as a disperser, a plasticizer, a surfactant, and/or a pH adjusting agent as component(s) in addition to the resin and the fine particles, provided that the coating liquid which contains such additive(s) does not impair the object of the present invention. Note that the additive(s) only need(s) to be added in an amount that does not impair the object of the present invention.

The coating liquid can be applied to the polyolefin porous film, i.e., a porous layer can be formed on a surface of the polyolefin porous film by any method that is not particularly limited. Examples of the method of forming the porous layer include a method in which a surface of a polyolefin porous film is directly coated with a coating liquid, and then a solvent (dispersion medium) is removed; a method in which a suitable support is coated with a coating liquid, a solvent (dispersion medium) is removed so as to form a porous layer, the porous layer and a polyolefin porous film are pressure-bonded, and then the support is peeled off; and a method in which a suitable support is coated with a coating liquid, a polyolefin porous film is pressure-bonded to a surface of the support which surface has been coated with the coating liquid, the support is peeled off, and then a solvent (dispersion medium) is removed.

The coating liquid can be applied to the polyolefin porous film by a conventionally publicly known method that is specifically exemplified by a gravure coater method, a dip coater method, a bar coater method, and a die coater method.

The solvent (dispersion medium) is typically removed by being dried. The solvent (dispersion medium) contained in the coating liquid can be replaced with another solvent before being dried.

### Embodiment 3: Nonaqueous Electrolyte Secondary Battery Member, Embodiment 4: Nonaqueous Electrolyte Secondary Battery

A member for a nonaqueous electrolyte secondary battery (hereinafter referred to as a “nonaqueous electrolyte secondary battery member”) in accordance with Embodiment 3 of the present invention includes: a positive electrode; a nonaqueous electrolyte secondary battery separator in accordance with Embodiment 1 of the present invention or a nonaqueous electrolyte secondary battery laminated separator in accordance with Embodiment 2 of the present invention; and a negative electrode, the positive electrode, the nonaqueous electrolyte secondary battery separator or the nonaqueous electrolyte secondary battery laminated separator, and the negative electrode being provided in this order.

A nonaqueous electrolyte secondary battery in accordance with Embodiment 4 of the present invention includes: a nonaqueous electrolyte secondary battery separator in accordance with Embodiment 1 of the present invention, or a nonaqueous electrolyte secondary battery laminated separator in accordance with Embodiment 2 of the present invention.

A nonaqueous electrolyte secondary battery in accordance with an embodiment of the present invention can be, for example, a nonaqueous secondary battery that achieves an electromotive force through doping and dedoping with lithium, and can include a nonaqueous electrolyte secondary battery member including a positive electrode, a nonaqueous electrolyte secondary battery separator in accordance with an embodiment of the present invention, and a negative electrode, the positive electrode, the nonaqueous electrolyte secondary battery separator, and the negative electrode being disposed in this order. Alternatively, a nonaqueous electrolyte secondary battery in accordance with an embodiment of the present invention can be, for example, a nonaqueous secondary battery that achieves an electromotive force through doping and dedoping with lithium, and can be a lithium ion secondary battery that includes a nonaqueous electrolyte secondary battery member including a positive electrode, a porous layer, a nonaqueous electrolyte secondary battery separator in accordance with an embodiment of the present invention, and a negative electrode, the positive electrode, the porous layer, the nonaqueous electrolyte secondary battery separator, and the negative electrode being disposed in this order, i.e., a lithium ion secondary battery that includes a nonaqueous electrolyte secondary battery member including a positive electrode, a nonaqueous electrolyte secondary battery laminated separator in accordance with an embodiment of the present invention, and a negative electrode, the positive electrode, the nonaqueous electrolyte secondary battery laminated separator, and the negative electrode being disposed in this order. Note that constituent elements, other than the nonaqueous electrolyte secondary battery separator, of the nonaqueous electrolyte secondary battery are not limited to those described below.

A nonaqueous electrolyte secondary battery in accordance with an embodiment of the present invention is ordinarily structured such that a battery element is enclosed in an exterior member, the battery element including a structure in which a negative electrode and a positive electrode face each other via a nonaqueous electrolyte secondary battery separator in accordance with an embodiment of the present invention or a nonaqueous electrolyte secondary battery laminated separator in accordance with an embodiment of the present invention and which is impregnated with an electrolyte. The nonaqueous electrolyte secondary battery is preferably a nonaqueous electrolytic secondary battery, and is particularly preferably a lithium ion secondary battery. Note that the doping means occlusion, support, adsorption, or insertion, and means a phenomenon in which lithium ions enter an active material of an electrode such as a positive electrode.

A nonaqueous electrolyte secondary battery member in accordance with an embodiment of the present invention includes a nonaqueous electrolyte secondary battery separator in accordance with an embodiment of the present invention or a nonaqueous electrolyte secondary battery laminated separator in accordance with an embodiment of the present invention. Thus, the nonaqueous electrolyte secondary battery member which is incorporated in a nonaqueous electrolyte secondary battery allows the nonaqueous electrolyte secondary battery to have a higher rate characteristic maintenance ratio after a cycle of charge and discharge of the nonaqueous electrolyte secondary battery. A nonaqueous electrolyte secondary battery in accordance with an embodiment of the present invention includes a nonaqueous electrolyte secondary battery separator in accordance with an embodiment of the present invention which nonaqueous electrolyte secondary battery separator has a photoelastic coefficient that is adjusted so as to fall within a specific range. Thus, the nonaqueous electrolyte secondary battery yields an effect of having an excellent rate characteristic maintenance ratio after a cycle of charge and discharge thereof.

<Positive Electrode>

A positive electrode included in each of a nonaqueous electrolyte secondary battery member in accordance with an embodiment of the present invention and a nonaqueous electrolyte secondary battery in accordance with an embodiment of the present invention is not limited to any particular one, provided that the positive electrode is one that is typically used as a positive electrode of a nonaqueous electrolyte secondary battery. Examples of the positive electrode include a positive electrode sheet having a structure in which an active material layer containing a positive electrode active material and a binder resin is formed on a current collector. Note that the active material layer can further contain an electrically conductive agent and/or a binding agent.

Examples of the positive electrode active material include a material capable of being doped and dedoped with lithium ions. Specific examples of such a material include a lithium complex oxide containing at least one transition metal such as V, Mn, Fe, Co, and Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one kind of the above electrically conductive agents, or to use two or more kinds of the above electrically conductive agents in combination.

Examples of the binding agent include (i) fluorine-based resins such as polyvinylidene fluoride, (ii) acrylic resin, and (iii) styrene butadiene rubber. Note that the binding agent also serves as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include a method in which a positive electrode active material, an electrically conductive agent, and a binding agent are pressure-molded on a positive electrode current collector; and a method in which (i) a positive electrode active material, an electrically conductive agent, and a binding agent are formed into a paste by use of a suitable organic solvent, (ii) a positive electrode current collector is coated with the paste, and (iii) the paste is dried and then pressured so as to be firmly fixed to the positive electrode current collector.

<Negative Electrode>

A negative electrode included in each of a nonaqueous electrolyte secondary battery member in accordance with an embodiment of the present invention and a nonaqueous electrolyte secondary battery in accordance with an embodiment of the present invention is not limited to any particular one, provided that the negative electrode is one that is typically used as a negative electrode of a nonaqueous electrolyte secondary battery. Examples of the negative electrode include a negative electrode sheet having a structure in which an active material layer containing a negative electrode active material and a binder resin is formed on a current collector. Note that the active material layer can further contain an electrically conductive agent.

Examples of the negative electrode active material include (i) a material capable of being doped and dedoped with lithium ions, (ii) a lithium metal, and (iii) a lithium alloy. Examples of the material include carbonaceous materials. Examples of the carbonaceous materials include natural graphite, artificial graphite, cokes, carbon black, and pyrolytic carbons.

Examples of the negative electrode current collector include electric conductors such as Cu, Ni, and stainless steel. Among these electric conductors, Cu is more preferable because Cu is not easily alloyed with lithium especially in the case of a lithium ion secondary battery and is easily processed into a thin film.

Examples of a method of producing the negative electrode sheet include a method in which a negative electrode active material is pressure-molded on a negative electrode current collector; and a method in which (i) a negative electrode active material is formed into a paste by use of a suitable organic solvent, (ii) a negative electrode current collector is coated with the paste, and (iii) the paste is dried and then pressured so as to be firmly fixed to the negative electrode current collector. The paste preferably contains the electrically conductive agent and the binding agent.

<Nonaqueous Electrolyte>

A nonaqueous electrolyte of a nonaqueous electrolyte secondary battery in accordance with an embodiment of the present invention is not limited to any particular one, provided that the nonaqueous electrolyte is one that is typically used as a nonaqueous electrolyte of a nonaqueous electrolyte secondary battery. Examples of the nonaqueous electrolyte include a nonaqueous electrolyte prepared by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts, or to use two or more kinds of the above lithium salts in combination.

Examples of the organic solvent which is contained in the nonaqueous electrolyte include carbonates, ethers, esters, nitriles, amides, carbamates, and sulfur-containing compounds, and a fluorine-containing organic solvent obtained by introducing a fluorine group into any of these organic solvents. It is possible to use only one kind of the above organic solvents, or to use two or more kinds of the above organic solvents in combination.

<Method of Producing Nonaqueous Electrolyte Secondary Battery Member and Method of Producing Nonaqueous Electrolyte Secondary Battery>

A nonaqueous electrolyte secondary battery member in accordance with an embodiment of the present invention can be produced by, for example, providing a positive electrode, a nonaqueous electrolyte secondary battery separator in accordance with an embodiment of the present invention or a nonaqueous electrolyte secondary battery laminated separator in accordance with an embodiment of the present invention, and a negative electrode in this order.

A nonaqueous electrolyte secondary battery in accordance with an embodiment of the present invention can be produced by, for example, (i) forming a nonaqueous electrolyte secondary battery member by the above-described method, (ii) placing the nonaqueous electrolyte secondary battery member in a container which is to serve as a housing of the nonaqueous electrolyte secondary battery, (iii) filling the container with a nonaqueous electrolyte, and then (iv) hermetically sealing the container under reduced pressure.

### EXAMPLES

The following description will more specifically discuss the present invention with reference to Examples and Comparative Examples. Note, however, that the present invention is not limited to the Examples.

### [Film Thickness, Weight Per Unit Area, True Density, Porosity]

Respective film thicknesses, respective weights per unit area, respective true densities, and respective porosities of nonaqueous electrolyte secondary battery separators (porous films) produced in Examples 1 and 2 and Comparative Examples 1 and 2 were calculated by processes described in (a) through (d) below.

(a) Film Thickness

A thickness of each of the polyolefin porous films produced in Examples and Comparative Examples below was measured in conformity with a JIS standard (K7130-1992) by use of a high-resolution digital measuring device (VL-50) manufactured by Mitutoyo Corporation.

(b) Weight Per Unit Area

A sample being 8 cm square was cut off from a porous film, and a weight W (g) of the sample was measured. Then, a weight per unit area of the porous film was calculated based on the following equation (1):

Weight per unit area(g/m²)=W/(0.08×0.08) (1)

(c) Measurement of True Density

A porous film was cut into a piece being 4 mm to 6 mm square, and the piece of the porous film was vacuum-dried at not more than 30° C. for 17 hours. Thereafter, a true density of the porous film was measured by a helium gas replacement method by use of a dry automatic densimeter (AccuPyc II 1340 manufactured by Micromeritics Instrument Corporation).

(d) Porosity

From the thicknesses [μm], the weight per unit area [g/m²], and the true density [g/m³] each calculated and measured in the processes described in (a) through (c) above, a porosity [%] of the porous film was calculated based on the following equation (2):

(Porosity)=[1−(weight per unit area)/{(thickness)×10⁻⁶×1 [m²]×(true density)}]×100 (2)

[Photoelastic Coefficient]

From each of the polyolefin porous films produced in Examples and Comparative Examples below, a piece measuring 6 cm (MD)×2 cm (TD) was cut out. On the piece of the polyolefin porous film, 0.5 mL of ethanol was dropped. The piece was impregnated with the ethanol, so that a semitransparent film was obtained. In this case, excess ethanol which had not been absorbed by the piece was wiped off and removed. Then, a birefringence at 25° C., with respect to light having a wavelength of 590 nm, of the semitransparent film thus obtained was measured by use of a phase difference measuring device manufactured by Oji Scientific Instruments (KOBRA-WPR). This birefringence was defined as a birefringence to be obtained in a case where a stress of 0 N is applied to the semitransparent film.

Subsequently, a birefringence of the semitransparent film to which a tension (stress) of 3 N was applied was measured by use of the phase difference measuring device. Further, by increasing, in increments of 1 N, the tension (stress), which was applied to the semitransparent film, so that the tension (stress) finally reached 9 N, birefringences of the semitransparent film to which respective tensions (stresses) were applied were measured by use of the phase difference measuring device. In a graph in which a stress applied is a horizontal axis and a birefringence obtained is a vertical axis, a least squares method was used to (i) draw a straight line based on points indicative of respective measurement results and (ii) calculate a slope of the straight line. The slope of the straight line was regarded as the photoelastic coefficient.

[Rate Characteristic Maintenance Ratio after 100 Cycles]

Each of nonaqueous electrolyte secondary batteries which had been produced in Examples and Comparative Examples and which had not been subjected to any charge and discharge cycle was subjected to four cycles of initial charge and discharge at 25° C. Each of the four cycles of the initial charge and discharge was carried out (i) at a voltage ranging from 2.7 V to 4.2 V, (ii) by CC-CV charge at a charge current value of 0.2 C (terminal current condition: 0.02 C), and (iii) by CC discharge at a discharge current value of 0.2 C. Note that 1 C is defined as a value of an electric current at which a rated capacity based on a discharge capacity at 1 hour rate is discharged for 1 hour. Note here that “CC-CV charge” is a charge method in which (i) a battery is charged at a set constant electric current, and (ii) after a given voltage is reached, the given voltage is maintained while the electric current is being reduced. Note also that “CC discharge” is a discharge method in which a battery is discharged at a set constant electric current until a given voltage is reached. Same applies to the following description.

A nonaqueous electrolyte secondary battery, which had been subjected to the initial charge and discharge, was subjected to (i) CC-CV charge at a charge current value of 1 C (terminal current condition: 0.02 C) and then (ii) CC discharge at discharge current values of 0.2 C, 1 C, 5 C, 10 C, and 20 C in this order. Three cycles of charge and discharge were carried out at 55° C. for each rate. In this case, the voltage ranged from 2.7 V to 4.2 V. Then, CC discharge was carried out at discharge current values of 0.2 C and 20 C. A ratio between (a) a discharge capacity in the third cycle in which the discharge current value was 20 C and (b) a discharge capacity in the third cycle in which the discharge current value was 0.2 C (20 C discharge capacity/0.2 C discharge capacity) was calculated as an initial rate characteristic before a cycle test.

Subsequently, the nonaqueous electrolyte secondary battery whose initial rate characteristic before the cycle test had been measured was subjected to 100 cycles of charge and discharge at 55° C. Each of the 100 cycles of the charge and discharge was carried out (i) at a voltage ranging from 2.7 V to 4.2 V, (ii) by CC-CV charge at a charge current value of 1 C (terminal current condition: 0.02 C), and (iii) by CC discharge at a discharge current value of 10 C. The nonaqueous electrolyte secondary battery, which had been subjected to the 100 cycles of the charge and discharge, was subjected to (i) CC-CV charge at a charge current value of 1 C (terminal current condition: 0.02 C) and then (ii) CC discharge at discharge current values of 0.2 C, 1 C, 5 C, 10 C, and 20 C in this order. In this case, the voltage ranged from 2.7 V to 4.2 V. Three cycles of charge and discharge were carried out at 55° C. for each rate. A ratio between (a) a discharge capacity in the third cycle in which the discharge current value was 20 C and (b) a discharge capacity in the third cycle in which the discharge current value was 0.2 C (20 C discharge capacity/0.2 C discharge capacity) was calculated as a rate characteristic after the 100 cycles.

In accordance with the initial rate characteristic and the rate characteristic after the 100 cycles, the initial rate characteristic and the rate characteristic each calculated as described above, a rate characteristic maintenance ratio after the 100 cycles was calculated based on the following equation (1):

Rate characteristic maintenance ratio (%) after 100 cycles=100×(rate characteristic after 100 cycles)/initial rate characteristic before cycle test (1)

### Example 1

Example 1 prepared (i) 18% by weight of an ultra-high molecular weight polyethylene powder (HI-ZEX MILLION 145M manufactured by Mitsui Chemicals, Inc.) and (ii) 2% by weight of a petroleum resin (hydrogenated, having a softening point of 90° C.) containing vinyl toluene, indene, and α-methylsthylene. The ultra-high molecular weight polyethylene powder and a powder of the petroleum resin were fracture-mixed by use of a blender until these powders had an identical particle size, so that a mixture was obtained. The mixture was fed through a quantitative feeder into a twin screw kneading extruder so that the mixture was melted and kneaded, so that a resultant product was obtained.

While the mixture was being melted and kneaded, 80% by weight of liquid paraffin was side-fed into the twin screw kneading extruder with a pump under pressure. Then, the mixture and the liquid paraffin were melted and kneaded together.

Thereafter, the resultant product was extruded through a T-die after having passed through a gear pump, so that a sheet polyolefin resin composition was obtained. The obtained sheet polyolefin resin composition was cooled, so that a roll of the sheet polyolefin resin composition was obtained.

The obtained sheet polyolefin resin composition was stretched at 117° C. in an MD direction 6.4 times, and then a stretch ratio was reduced in the MD direction to 4.2 times before the stretch ratio was fixed. In this case, a maintenance ratio of the stretch ratio was 66%. Subsequently, the sheet polyolefin resin composition which had been stretched in the MD direction was stretched at 115° C. in a TD direction 6.0 times. Thereafter, the sheet polyolefin resin composition thus stretched was impregnated with heptane and cleaned.

The polyolefin resin composition from which an additive had been removed was dried at a room temperature and then dried by heating in an oven at 129° C., so that a polyolefin porous film was produced. The produced polyolefin porous film is referred to as a polyolefin porous film 1. The polyolefin porous film 1 had a thickness of 15.5 μm and a porosity of 48%.

### Example 2

Example 2 prepared (i) 18% by weight of an ultra-high molecular weight polyethylene powder (HI-ZEX MILLION 145M manufactured by Mitsui Chemicals, Inc.) and (ii) 2% by weight of a petroleum resin (hydrogenated, having a softening point of 125° C.) containing vinyl toluene, indene, and α-methylsthylene. The ultra-high molecular weight polyethylene powder and a powder of the petroleum resin were fracture-mixed by use of a blender until these powders had an identical particle size, so that a mixture was obtained. The mixture was fed through a quantitative feeder into a twin screw kneading extruder so that the mixture was melted and kneaded, so that a resultant product was obtained.

While the mixture was being melted and kneaded, 80% by weight of liquid paraffin was side-fed into the twin screw kneading extruder with a pump under pressure. Then, the mixture and the liquid paraffin were melted and kneaded together.

Thereafter, the resultant product was extruded through a T-die after having passed through a gear pump, so that a sheet polyolefin resin composition was obtained. The obtained sheet polyolefin resin composition was cooled, so that a roll of the sheet polyolefin resin composition was obtained.

The obtained sheet polyolefin resin composition was stretched at 117° C. in an MD direction 6.4 times, and then a stretch ratio was reduced in the MD direction to 4.5 times before the stretch ratio was fixed. In this case, a maintenance ratio of the stretch ratio was 70%. Subsequently, the sheet polyolefin resin composition which had been stretched in the MD direction was stretched at 115° C. in a TD direction 6.0 times. Thereafter, the sheet polyolefin resin composition thus stretched was impregnated with heptane and cleaned.

The polyolefin resin composition from which an additive had been removed was dried at a room temperature and then dried by heating in an oven at 129° C., so that a polyolefin porous film was produced. The produced polyolefin porous film is referred to as a polyolefin porous film 2. The polyolefin porous film 2 had a thickness of 15.5 μm and a porosity of 55%.

### Comparative Example 1

Comparative Example 1 prepared 20% by weight of an ultra-high molecular weight polyethylene powder (HI-ZEX MILLION 145M manufactured by Mitsui Chemicals, Inc.). The ultra-high molecular weight polyethylene powder was fed through a quantitative feeder into a twin screw kneading extruder so as to be melted and kneaded, so that a resultant product was obtained.

While the ultra-high molecular weight polyethylene powder was being melted and kneaded, 80% by weight of liquid paraffin was side-fed into the twin screw kneading extruder with a pump under pressure. Then, the ultra-high molecular weight polyethylene powder and the liquid paraffin were melted and kneaded together.

Thereafter, the resultant product was extruded through a T-die after having passed through a gear pump, so that a sheet polyolefin resin composition was obtained. The obtained sheet polyolefin resin composition was cooled, so that a roll of the sheet polyolefin resin composition was obtained.

The obtained sheet polyolefin resin composition was stretched at 117° C. in an MD direction 6.4 times, and then a stretch ratio was reduced in the MD direction to 3.2 times before the stretch ratio was fixed. In this case, a maintenance ratio of the stretch ratio was 50%. Subsequently, the sheet polyolefin resin composition which had been stretched in the MD direction was stretched at 115° C. in a TD direction 6.0 times. Thereafter, the sheet polyolefin resin composition thus stretched was impregnated with heptane and cleaned.

The polyolefin resin composition which had been cleaned was dried at a room temperature and then dried by heating in an oven at 127° C., so that a polyolefin porous film was produced. The produced polyolefin porous film is referred to as a polyolefin porous film 3. The polyolefin porous film 3 had a thickness of 18.9 μm and a porosity of 49%.

### Comparative Example 2

A polyolefin porous film (nonaqueous electrolyte secondary battery separator), which is a commercially-available product, was referred to as a polyolefin porous film 4. The polyolefin porous film 4 had a thickness of 25.6 μm and a porosity of 42%.

[Production of Nonaqueous Electrolyte Secondary Battery]

A nonaqueous electrolyte secondary battery was produced by the following method by using, as a nonaqueous electrolyte secondary battery separator, each of the polyolefin porous films 1 through 4 described in Examples 1 and 2 and Comparative Examples 1 and 2.

(Production of Positive Electrode)

A commercially-available positive electrode produced by applying LiNi_{0.5}Mn_{0.3}Co_{0.2}O₂/electrically conductive agent/PVDF (weight ratio 92/5/3) to aluminum foil was used to produce the nonaqueous electrolyte secondary battery. The aluminum foil was cut out of the commercially-available positive electrode so as to have (i) a first part provided with a positive electrode active material layer and having a size of 45 mm×30 mm and (ii) a second part remaining around the first part while being provided with no positive electrode active material layer and having a width of 13 mm. A positive electrode thus obtained was used to produce the nonaqueous electrolyte secondary battery. The positive electrode active material layer had a thickness of 58 μm, a density of 2.50 g/cm³, and a positive electrode capacity of 174 mAh/g.

(Production of Negative Electrode)

A commercially-available negative electrode produced by applying graphite/styrene-1,3-butadiene copolymer/sodium carboxymethyl cellulose (weight ratio 98/1/1) to copper foil was used to produce the nonaqueous electrolyte secondary battery. The copper foil was cut out of the commercially-available negative electrode so as to have (i) a first part provided with a negative electrode active material layer and having a size of 50 mm×35 mm and (ii) a second part remaining around the first part while being provided with no negative electrode active material layer and having a width of 13 mm. A negative electrode thus obtained was used to produce the nonaqueous electrolyte secondary battery. The negative electrode active material layer had a thickness of 49 μm, a density of 1.40 g/cm³, and a negative electrode capacity of 372 mAh/g.

(Assembly of Nonaqueous Electrolyte Secondary Battery)

A nonaqueous electrolyte secondary battery member was obtained by disposing (providing), in a laminate pouch, the positive electrode, the polyolefin porous film serving as a nonaqueous electrolyte secondary battery separator, and the negative electrode in this order. In this case, the positive electrode and the negative electrode were provided so that a whole of a main surface of the positive electrode active material layer of the positive electrode was included in a range of a main surface (overlapped the main surface) of the negative electrode active material layer of the negative electrode.

Subsequently, the nonaqueous electrolyte secondary battery member was put in a bag including an aluminum layer and a heat seal layer disposed on the aluminum layer, and 0.25 mL of a nonaqueous electrolyte was further poured into the bag. The nonaqueous electrolyte was an electrolyte at 25° C. prepared by dissolving LiPF₆ in a mixed solvent of ethyl methyl carbonate, diethyl carbonate, and ethylene carbonate in a volume ratio of 50:20:30 so that the concentration of LiPF₆ in the electrolyte was 1.0 mole per liter. The bag was heat-sealed while a pressure inside the bag was reduced, so that a nonaqueous electrolyte secondary battery was produced. The nonaqueous electrolyte secondary battery had a design capacity of 20.5 mAh. Nonaqueous electrolyte secondary batteries each produced by using a corresponding one of the polyolefin porous films 1 through 4 as the polyolefin porous film are referred to as respective nonaqueous electrolyte secondary batteries 1 through 4.

[Results]

The following Table 1 shows a “film thickness”, a “weight per unit area”, and a “photoelastic coefficient” of each of the polyolefin porous films 1 through 4 described in Examples 1 and 2 and Comparative Examples 1 and 2, and a “rate characteristic maintenance ratio after 100 cycles” of each of the nonaqueous electrolyte secondary batteries 1 through 4 produced by use of the respective polyolefin porous films 1 through 4 described in Examples 1 and 2 and Comparative Examples 1 and 2.

TABLE 1

| | | | | Rate charac- |
|---|---|---|---|---|
| | | | | teristic main- |
| | Film | Weight per | Photoelastic | tenance ratio |
| | thickness | unit area | coefficient | after 100 cycles |
| | [μm] | [g/m²] | [×10⁻¹¹ m²/N] | [%] |
| Example 1 | 15.5 | 7.5 | 11.9 | 56 |
| Example 2 | 15.5 | 6.5 | 12.6 | 73 |
| Comparative | 18.9 | 8.9 | 20.4 | 35 |
| Example 1 | | | | |
| Comparative | 25.9 | 13.9 | 2.3 | 37 |
| Example 2 | | | | |

### CONCLUSION

As shown in Table 1, the nonaqueous electrolyte secondary battery in which the nonaqueous electrolyte secondary battery separator including (i) the polyolefin porous film 3 described in Comparative Example 1 and having a photoelastic coefficient of more than 20×10⁻¹¹ m²/N or (ii) the polyolefin porous film 4 described in Comparative Example 2 and having a photoelastic coefficient of less than 3.0×10⁻¹¹ m²/N was incorporated had a rate characteristic maintenance ratio after 100 cycles of 35% or 37%. In contrast, the nonaqueous electrolyte secondary battery in which the nonaqueous electrolyte secondary battery separator including the polyolefin porous film 1 had a rate characteristic maintenance ratio after 100 cycles of 56% (Example 1), and the nonaqueous electrolyte secondary battery in which the nonaqueous electrolyte secondary battery separator including the polyolefin porous film 2 had a rate characteristic maintenance ratio after 100 cycles of 73% (Example 2). This reveals that both of Examples 1 and 2 were higher in rate characteristic maintenance ratio after 100 cycles than Comparative Examples 1 and 2.

The above description reveals that a nonaqueous electrolyte secondary battery separator in accordance with an embodiment of the present invention allows a nonaqueous electrolyte secondary battery to have a higher rate characteristic maintenance ratio after a cycle of charge and discharge of the nonaqueous electrolyte secondary battery.

### INDUSTRIAL APPLICABILITY

A nonaqueous electrolyte secondary battery separator in accordance with an embodiment of the present invention allows a nonaqueous electrolyte secondary battery including the nonaqueous electrolyte secondary battery separator to have a higher rate characteristic maintenance ratio after a cycle of charge and discharge of the nonaqueous electrolyte secondary battery. This allows the nonaqueous electrolyte secondary battery separator in accordance with an embodiment of the present invention to be suitably used in various industries dealing in nonaqueous electrolyte secondary batteries.

1. A nonaqueous electrolyte secondary battery separator comprising:
a polyolefin porous film,
the nonaqueous electrolyte secondary battery separator having a photoelastic coefficient of not less than 3.0×10⁻¹¹ m²/N and not more than 20×10⁻¹¹ m²/N with respect to light having a wavelength of 590 nm.

2. A nonaqueous electrolyte secondary battery laminated separator comprising:
a nonaqueous electrolyte secondary battery separator recited in claim 1; and
an insulating porous layer.

3. A nonaqueous electrolyte secondary battery member comprising:
a positive electrode;
a nonaqueous electrolyte secondary battery separator recited in claim 1; and
a negative electrode,
the positive electrode, the nonaqueous electrolyte secondary battery separator, and the negative electrode being provided in this order.

4. A nonaqueous electrolyte secondary battery member comprising:
a positive electrode;
a nonaqueous electrolyte secondary battery laminated separator recited in claim 2; and
a negative electrode,
the positive electrode, the nonaqueous electrolyte secondary battery laminated separator, and the negative electrode being provided in this order.

5. A nonaqueous electrolyte secondary battery comprising:
a nonaqueous electrolyte secondary battery separator recited in claim 1.

6. A nonaqueous electrolyte secondary battery comprising:
a nonaqueous electrolyte secondary battery laminated separator recited in claim 2.
